(19) United States
(12) Patent Application Publication
(10) Pub. No.: US 2013/0125345 A1
(43) Pub. Date: May 23, 2013

(54) DOOR HANDLE FOR A DOMESTIC APPLIANCE

(71) Applicants: Trevor Specht, Rothenburg (DE); Branko Ivanovic, Wurzburg (DE); Dietmar Hilder, Furth (DE); Bernd Heisswolf, Rothenburg (DE)

(72) Inventors: Trevor Specht, Rothenburg (DE); Branko Ivanovic, Wurzburg (DE); Dietmar Hilder, Furth (DE); Bernd Heisswolf, Rothenburg (DE)

(73) Assignee: ELECTROLUX HOME PRODUCTS CORPORATION N.V., Brussel (BE)

(21) Appl. No.: 13/639,889

(22) PCT Filed: May 13, 2011
(86) PCT No.: PCT/EP2011/002377

§ 371 Date: Jan. 7, 2013

(30) Foreign Application Priority Data
May 14, 2010 (EP) 10005102.8
Feb. 15, 2011 (EP) 11001200.2

(51) Int. Cl. E05B 1/00

(52) U.S. Cl. CPC E05B 1/00
USPC 16/413; 16/412; 16/436

(57) ABSTRACT

The present invention relates to a door handle for a domestic appliance. The door handle includes a handle bar (10) and a fastening part (12). The fastening part (12) is a single-piece part and comprises at least two contact elements (14) and a bracket portion (16). The bracket portion (16) connects the contact elements (14). The contact elements (14) comprise one free side opposite to the bracket portion (16) in each case. The free sides of the contact elements (14) are attached or attachable at a door of the domestic appliance. The bracket portion (16) comprises at least one outer side opposite to the contact elements (14). The handle bar (10) is formed as a profile part with one open longitudinal side. At least one inner side of the profile part of the handle bar (10) is at least partially complementary to the at least one outer side of the bracket portion (16). Further, present invention relates to a domestic appliance with such a door handle.

The present invention relates to a door handle for a domestic appliance. Further, the present invention relates to a domestic appliance.

Domestic appliances, like cooking ovens and refrigerators, comprise at least one door handle for opening and closing a corresponding door. Usually the door handle includes a handle part, which can be partially or completely enclosed by the user's hand. A further part of the door handle is provided for fastening said door handle at the door.

DE 103 03 734 B4 discloses a door handle for a domestic appliance. The door handle comprises one or two fixing parts and a handle part. The handle part is directly fixed at the one or two fixing parts by form locking connection.

DE 10 2006 042 176 A1 discloses a door handle for a domestic appliance. The door handle comprises a longitudinal handle part and at least one fixing part. The surfaces of the handle part and the fixing part are made of the same material.

DE 299 14 024 U1 discloses a door handle for a drawer. The door handle comprises a handle part and a fixing part. Between the transparent handle part and the fixing part an indicating label is arranged.

It is an object of the present invention to provide an improved door handle for a domestic appliance, which door handle is realized by low cost of materials.

The object of the present invention is achieved by the door handle for a domestic appliance according to claim 1.

The present invention relates to a door handle for a domestic appliance, wherein:
the door handle includes a handle bar and a fastening part,
the fastening part is a single-piece part and comprises at least two contact elements and a bracket portion,
the bracket portion connects the contact elements,
the contact elements comprise one free side opposite to the bracket portion in each case,
the free sides of the contact elements are attached or attachable at a door of the domestic appliance,
the bracket portion comprises at least one outer side opposite to the contact elements,
the handle bar is formed as a profile part with one open longitudinal side, and
at least one inner side of the profile part of the handle bar is at least partially complementary to the at least one outer side of the bracket portion.

The main idea of the present invention is the door handle with the fastening part, wherein the fastening part is the substantial part of said door handle. The physical properties of the door handle arise from the fastening part. The handle bar is substantially provided for the aesthetic properties of the door handle.

The door handle according to the present invention allows that the handle bar is mountable at, removable from and exchangeable on the fastening part without removing said fastening part from the door. The functional capability of the door handle is given by the fastening part only. In contrast, the handle bar is irrelevant for the functional capability of the door handle. The handle bar is mountable, removable and exchangeable without any intervention into the structure of the door. If an unauthorized person intervenes into the structure of the door, then the warranty and/or the certification of the domestic appliance would be invalid.

Since the handle bar is mountable without any intervention into the structure of the door, said handle bar may be mounted, removed or exchanged by an arbitrary assembler in a simple way. It is not necessary that the handle bar is mounted, removed or exchanged by the producer of the door. Thus, the design of the door handle may by be adapted to the design of neighbouring furniture by arbitrary persons in simple way.

According to a preferred embodiment of the present invention the handle bar is formed as a U-shaped profile part. The handle bar can be produced as an extruded profile part, wherein any finishing treatment is not required. This contributes to low complexity and low costs.

In particular, the bracket portion comprises three outer sides opposite to the contact elements. The three outer sides of the bracket portion are provided to be enclosed by the handle bar formed as profile part, in particular form as U-shaped profile part.

Preferably, the fastening part is made of a material with low heat conductivity. Thus, the door handle can be used at a domestic appliance generating extreme temperatures, like cooking ovens or freezers. The fastening part acts as a thermal isolator, so that the user can touch the door handle without any problems.

For example, the fastening part is made of plastics. Plastics have low heat conductivity and are low cost materials.

Further, the handle bar is made of metal or coated by metal. Since the fastening part is made of the material with low heat conductivity, the handle bar may include metal without any problems for the user. The designer has more possibilities for creating the door design.

For example, the two contact elements are arranged at the both ends of the bracket portion. In this case the fastening part has a typical form for the door handle.

The handle bar is removable attached or attachable at the bracket portion of the fastening element. This allows an easy exchange of the handle bar.

In particular, the handle bar is attached or attachable at the bracket portion of the fastening element by a snap-in mechanism.

Alternatively, the handle bar may be attached or attachable at the bracket portion of the fastening element by a screw joint.

In the case of the above screw joint one or more screws may be inserted or insertable on a front side of the handle bar and/or on a rear side of the bracket portion. For example, two screws may be inserted or insertable on the rear side of the bracket portion, so that the design of the handle bar is not impaired by said screws. According to another example, two screws may be inserted or insertable on the rear side of the door, wherein each screw penetrates a channel through the door and through the corresponding contact element and engages with the handle bar, so that said screws do not intervene into the structure of the door.

Further, the handle bar may be permanently attached or attachable at the bracket portion of the fastening element. In this case, the handle bar may be attached or attachable at the bracket portion of the fastening element by an adhesive joint.

Preferably, the handle bar comprises at least one centring element corresponding to a complementary element in the bracket portion of the fastening part in order to align the handle bar with the fastening part.

For example, the at least one centring element is a pin element arranged at least partially within the profile part of the handle bar.

At last, the present invention relates to a domestic appliance with at least on door, wherein the domestic appliance comprises at least one door handle as described above.

Novel and inventive features of the present invention are set forth in the appended claims.

The present invention will be described in further detail with reference to the drawings, in which

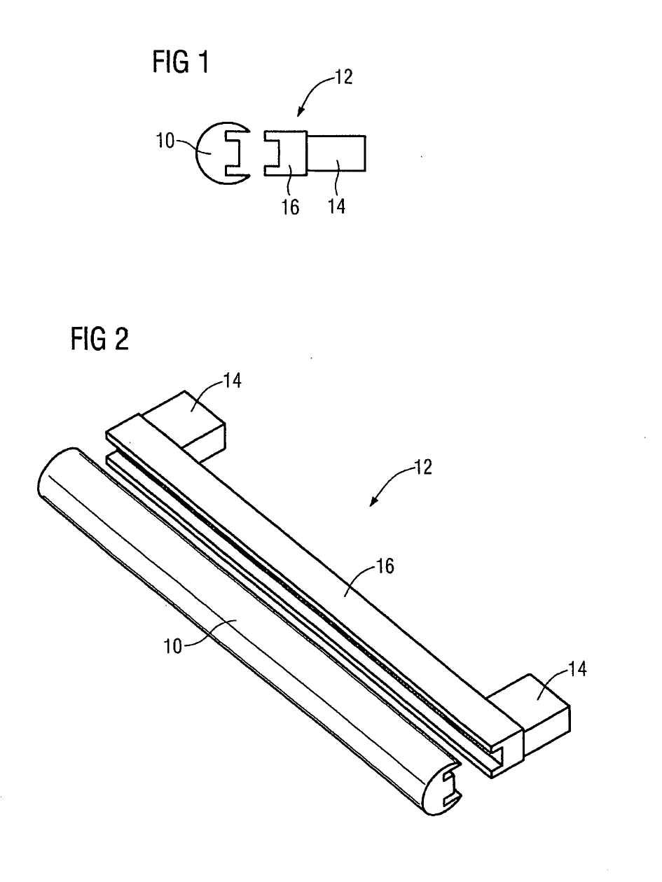

FIG. 1 illustrates a sectional side view of a handle bar and a fastening part for a door handle according to a first embodiment of the present invention,

FIG. 2 illustrates a perspective view of the handle bar and the fastening part for the door handle according to the first embodiment of the present invention,

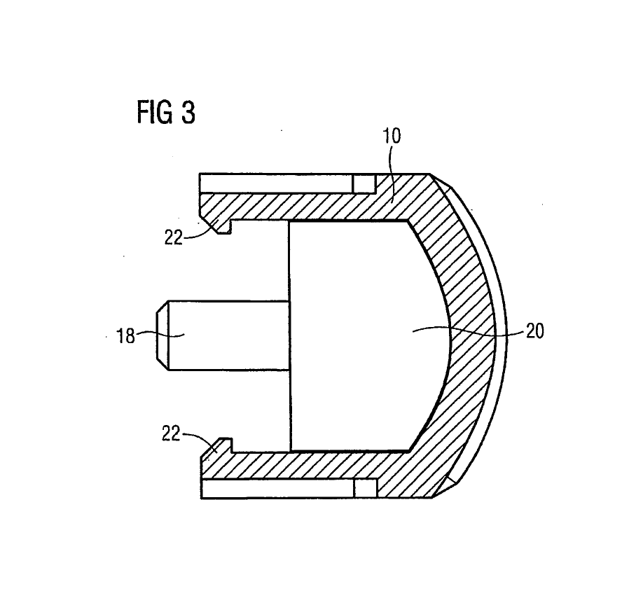

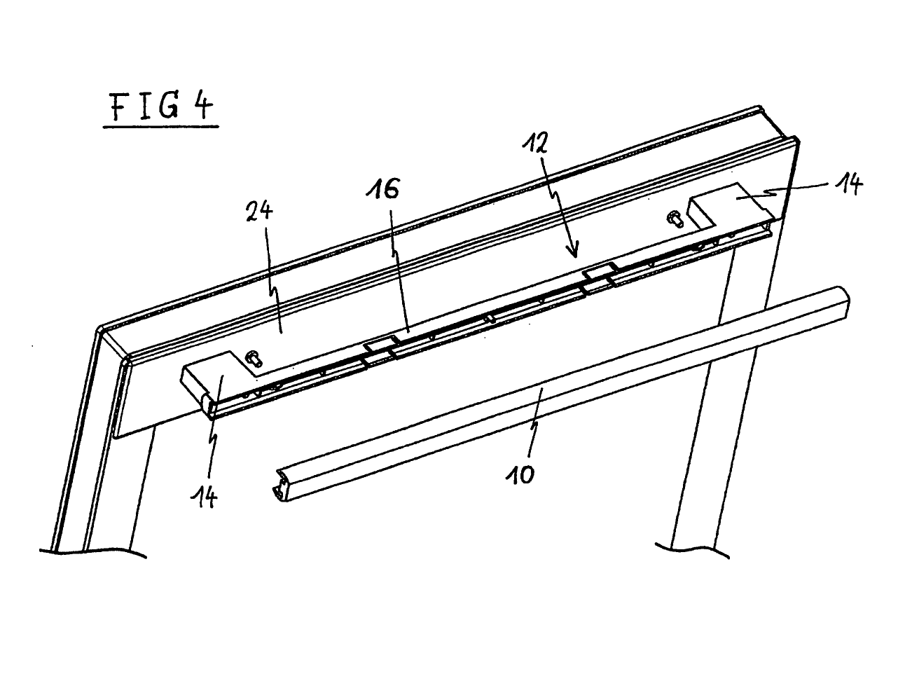

FIG. 3 illustrates a sectional side view of the handle bar for the door handle according to a second embodiment of the present invention, and

FIG. 4 illustrates a perspective view of the handle bar and the fastening part of the door handle at an oven door according to a third embodiment of the present invention.

FIG. 1 illustrates a sectional side view of a handle bar 10 and a fastening part 12 for a door handle according to a first embodiment of the present invention.

The door handle is composed of the handle bar 10 and the fastening part 12. In this example, the handle bar 10 as well as the fastening part 12 are formed as single-piece parts in each case.

The handle bar 10 is formed as a U-shaped profile part. For example, the handle bar 10 is made of plastics, and the outer side of the handle bar 10 is coated by metal. Alternatively, the handle bar 10 is completely made of metal. Further, the handle bar 10 can be made of ceramics or glass.

The fastening part 12 includes two contact elements 14 and a longitudinal bracket portion 16. The bracket portion 16 connects the both contact elements 14. The bracket portion 16 forms a bridge between the both contact elements 14. The bracket portion 16 comprises an inner long side and three outer long sides. The contact elements 14 are attached at the inner long side of the bracket portion 16. In this example, the contact elements 14 are attached at the both ends of the inner long side of the bracket portion 16. Alternatively, more than two contact elements 14 may be attached at the inner long side of the bracket portion 16.

The inner sides of the U-shaped profile part of the handle bar 10 are complementary to the outer long sides of the bracket portion 16. Thus, the handle bar 10 can attached at the bracket portion 16. The handle bar 10 and the bracket portion 16 have the same length, so that the handle bar 10 covers completely the outer sides of the bracket portion 16.

The handle bar 10 may be fixed at the bracket portion 16 of the fastening part 12 by a screw joint, a snap-in mechanism and/or an adhesive joint. The snap-in mechanism may act, when the handle bar 10 is pushed onto the bracket portion 16 of the fastening part 12 perpendicular to the longitudinal axes of the handle bar 10 and the bracket portion 16. Further, the handle bar 10 may be pushed onto the bracket portion 16 of the fastening part 12 along the longitudinal axes of the handle bar 10 and the bracket portion 16.

When the handle bar 10 is fixed at the bracket portion 16 of the fastening part 12 by the screw joint or the snap-in mechanism, then the handle bar 10 may be exchanged in an easy way. A fast exchange of the handle bar 10 is also possible, if the handle bar 10 is pushed onto the bracket portion 16 of the fastening part 12 along the longitudinal axes of the handle bar 10 and the bracket portion 16.

If the fastening part 12 is made of plastics or another material with low heat conductivity, then the fastening part 12 acts as heat insulator. This is advantageous, if the domestic appliance is a cooking oven, a freezer or another apparatus generating extremely high or low temperatures.

In general, the handle bar 10 as well as the fastening part 12 can be made of plastics, metal, ceramics and/or glass.

FIG. 2 illustrates a perspective view of the handle bar 10 and the fastening part 12 for the door handle according to the first embodiment of the present invention. FIG. 2 clarifies the geometric relationships of the handle bar 10 and the fastening part 12.

The handle bar 10, the bracket portion 16 of the fastening part 12 and the fastening part 12 as a whole have the same lengths. The contact elements 14 of the fastening part 12 are arranged at the both ends of the inner side of the bracket portion 16. In this example, the contact elements 14 of the fastening part 12 are substantially block-shaped.

FIG. 3 illustrates a sectional side view of the handle bar 10 for the door handle according to a second embodiment of the present invention.

The handle bar 10 of the second embodiment comprises additionally at least one pin element 18 and at least one rib 20. The handle bar 10 is partially formed as the U-shaped profile part. The at least one rib 20 reinforces the handle bar 10. The at least one pin element 18 is provided for penetrating into a corresponding hole of the fastening part 12 in order to position the handle bar 10 with respect to said fastening part 12.

Further, the cross-section of the handle bar 10 comprises two hooks 22 at the open ends of its inner side. The hooks 22 extend continuous or in sections along the longitudinal axis of the handle bar 10. The hooks 22 and complementary grooves or edges at the fastening part 12 form the snap-in mechanism.

FIG. 4 illustrates a perspective view of the handle bar 10 and the fastening part 12 of the door handle at an oven door 24 according to a third embodiment of the present invention.

The contact elements 14 of the fastening part 12 are arranged at the both ends of the inner side of the bracket portion 16. Also in this example, the contact elements 14 of the fastening part 12 are substantially block-shaped. The bracket portion 16 and the contact elements 14 form a single-piece part. The handle bar 10, the bracket portion 16 of the fastening part 12 and the fastening part 12 as a whole have substantially the same lengths.

The fastening part 12 is fixed by screws at the oven door 24. For example, the screws penetrate the oven door 24 from the inner side of said oven door 24 and engage with the contact elements 14. Alternatively, the screws penetrate the contact elements 14 and engage with the oven door 24.

The handle bar 10 is fixed at the fastening part 12 by screws from the rear side. For example, the screws may penetrate the oven door 24, the contact elements 14 as well as the bracket portion 16 and engage with the handle bar 10. In this case, a common channel penetrates the oven door 24, the contact elements 14 and the bracket portion 16 in each case, wherein said channel is provided for a corresponding screw.

Alternatively or additionally, the screws may penetrate the bracket portion 16 only and engage with the handle bar 10, so that the handle bar 10 is fixed at the fastening part 12 from the rear side.

The handle bar 10 is formed as a profile part. The inner side of the profile part of the handle bar 10 is partially complementary to the outer side of the bracket portion 16. Instead of screws, the handle bar 10 may be attached at the bracket portion 16 of the fastening element 12 by a snap-in mechanism.

The door handle according to the present invention comprises a standard basis part and a variable design part. The fastening part 12 plays the role of the standard basis part, which can be used for different doors and different domestic appliances, respectively. The handle bar 10 plays the role of the variable design part. A plurality of different handle parts 10 allows a variation of the design for the doors and the domestic appliances. The handle bar 10 can easily be exchanged.

The inventive door handle allows that the handle bar 10 is mountable at, removable from and exchangeable on the fastening part 16 without removing said fastening part from a door. The functional capability of the door handle is given by the fastening part 16 only. In contrast, the handle bar 10 is irrelevant for the functional capability of the door handle. The handle bar 10 is mountable, removable and exchangeable without any intervention into the structure of the door 24. If an unauthorized person intervenes into the structure of the door 24, then the certification and/or the warranty of the domestic appliance would be invalid.

Since the handle bar 10 is mountable without any intervention into the structure of the door 24, said handle bar may be mounted, removed or exchanged by an arbitrary assembler in a simple way. It is not necessary that the handle bar 10 is mounted, removed or exchanged by the producer of the door 24. Thus, the design of the door handle may by be adapted to the design of neighbouring furniture in simple way by arbitrary persons.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 handle bar
12 fastening part
14 contact element
16 bracket portion
18 pin element
20 rib
22 hook
24 oven door

1. A door handle for a domestic appliance, wherein:
the door handle includes a handle bar (10) and a fastening part (12),
the fastening part (12) is a single-piece part and comprises at least two contact elements (14) and a bracket portion (16),
the bracket portion (16) connects the contact elements (14), the contact elements (14) comprise one free side opposite to the bracket portion (16) in each case,
the free sides of the contact elements (14) are attached or attachable at a door of the domestic appliance, the bracket portion (16) comprises at least one outer side opposite to the contact elements (14),
the handle bar (10) is formed as a profile part with one open longitudinal side, and
at least one inner side of the profile part of the handle bar (10) is at least partially complementary to the at least one outer side of the bracket portion (16).

2. The door handle according to claim 1, characterized in, that the handle bar (10) is formed as a U-shaped profile part.

3. The door handle according to claim 1, characterized in, that the bracket portion (16) comprises three longitudinal outer sides opposite to the contact elements (14).

4. The door handle according to claim 1 characterized in, that the fastening part (12) is made of a material with low heat conductivity.

5. The door handle according to claim 4, characterized in, that the fastening part (12) is made of plastics.

6. The door handle according to claim 1 characterized in, that the handle bar (10) is made of metal or coated by metal.

7. The door handle according to claim 1 characterized in, that the two contact elements (14) are arranged at the both ends of the bracket portion (16).

8. The door handle according to claim 1 characterized in, that the handle bar (10) is removable attached or attachable at the bracket portion (16) of the fastening element (12).

9. The door handle according to claim 8, characterized in, that the handle bar (10) is attached or attachable at the bracket portion (16) of the fastening element (12) by a snap-in mechanism (22).

10. The door handle according to claim 8, characterized in, that the handle bar (10) is attached or attachable at the bracket portion (16) of the fastening element (12) by a screw joint.

11. The door handle according to claim 1 characterized in, that the handle bar (10) is permanently attached or attachable at the bracket portion (16) of the fastening element (12).

12. The door handle according to claim 11, characterized in, that the handle bar (10) is attached or attachable at the bracket portion (16) of the fastening element (12) by an adhesive joint.

13. The door handle according to claim 1 characterized in, that the handle bar (10) comprises at least one centring element (18) corresponding to a complementary element of the fastening part (12) in order to align the handle bar (10) with the fastening part (12).

14. The door handle according to claim 13, characterized in, that the at least one centring element is a pin element (18) arranged at least partially within the profile part of the handle bar (10).

15. A domestic appliance with at least on door, characterized in, that the domestic appliance comprises at least one door handle according to claim 1.
